(19) United States
(12) Patent Application Publication
(10) Pub. No.: US 2024/0070041 A1
(43) Pub. Date: Feb. 29, 2024

(54) METHOD AND SYSTEM FOR GENERATING TEST INPUTS FOR FAULT DIAGNOSIS

(71) Applicant: Novity, Inc., San Carlos, CA (US)

(72) Inventors: Ion Matei, Mountain View, CA (US); Maksym l. Zhenirovskyy, Mountain View, CA (US); John Turner Maxwell, III, Santa Clara, CA (US); Johan de Kleer, Los Altos, CA (US)

(73) Assignee: Novity, Inc., San Carlos, CA (US)

(21) Appl. No.: 18/352,123

(22) Filed: Jul. 13, 2023

Related U.S. Application Data
(60) Provisional application No. 63/401,984, filed on Aug. 29, 2022.

(51) Int. Cl. G06F 11/263; G06F 11/22; G06F 11/26

(52) U.S. Cl. CPC G06F 11/263; G06F 11/2263; G06F 11/2273; G06F 11/261

(57) ABSTRACT

One embodiment provides a method and a system for diagnosing faults in a physical system. During operation, the system can create a fault-augmented model of the physical system by considering various potential faults, and it can generate a machine-learning model to predict an operation mode of the physical system using the outputs of the physical system. A respective operation mode corresponds to normal operation or a potential fault in the physical system. The system can generate a plurality of training samples based on the fault-augmented model, use the training samples to train the machine-learning model to learn a sequence of inputs and model parameters that minimizes an uncertainty of the predicted operation mode, and then apply the learned sequence of inputs and the trained machine-learning model on the physical system to determine the operation mode of the physical system.

### RELATED APPLICATIONS

This application claims the benefit of U.S. Provisional Application No. 63/401,984, Attorney Docket Number PARC-20220044US01, titled “A HYBRID APPROACH TO UNCERTAINTY REDUCING TEST INPUTS GENERATION FOR FAULT DIAGNOSIS,” by inventors Ion Matei, Maksym Zhenirovskyy, John T. Maxwell III, and Johan de Kleer, filed on 29 Aug. 2022, the disclosure of which is incorporated herein by reference in its entirety.

### BACKGROUND

### Field

This disclosure is generally related to fault diagnostics of physical systems. More specifically, this disclosure is related to a machine-learning approach to estimate the most likely fault mode.

### Related Art

Fault diagnosis of physical systems can play an important role in ensuring the safety and reliability of the physical systems. Fast and accurate detection and diagnosis of the system fault can increase production and reduce downtimes. In recent years, machine-learning-based techniques (e.g., neural networks) have been used in fault detection and diagnosis. However, existing machine-learning approaches often face the problem of classification uncertainties.

### SUMMARY

One embodiment provides a method and a system for diagnosing faults in a physical system. During operation, the system can create a fault-augmented model of the physical system by considering various potential faults, and it can also generate a machine-learning model to predict the operation mode of the physical system based on outputs of the physical system. A respective operation mode corresponds to normal operation or a potential fault in the physical system. The system can use the fault-augmented model to generate a plurality of training samples, use the training samples to train the machine-learning model to learn a sequence of inputs and model parameters that minimizes uncertainty of the predicted operation mode, and then apply the learned sequence of inputs and the trained machine-learning model on the physical system to determine the operation mode of the physical system.

In a variation on this embodiment, the fault-augmented model can include a neural network, and constructing the fault-augmented model can include simulating behaviors of the physical system using a physics-based model to obtain training data to train the neural network.

In a variation on this embodiment, constructing the fault-augmented model can include extracting a set of differential equations from a physics-based model of the physical system and representing the differential equations as objects in a machine-learning platform upon which the machine-learning model is constructed.

In a further variation, the physics-based model can include a Modelica model.

In a variation on this embodiment, generating the training samples can include generating an approximate smooth representation of a sequence of inputs by approximating a step function with a sigmoid function.

In a variation on this embodiment, generating the training samples can include adding white Gaussian noise to outputs of the fault-augmented model.

In a variation on this embodiment, training the machine-learning model can include applying a gradient descent algorithm.

In a variation on this embodiment, the machine-learning model can include a recurrent neural network (RNN)-based classifier.

### BRIEF DESCRIPTION OF THE FIGURES

FIG. 1 illustrates an exemplary block diagram of the fault diagnostic system, according to one embodiment of the instant application.

FIG. 2 illustrates the architecture of an exemplary classifier, according to one embodiment of the instant application.

FIG. 3 illustrates the two exemplary approaches for modeling a physical system, according to one embodiment of the instant application.

FIG. 4A illustrates an exemplary to-be-diagnosed analog circuit.

FIG. 4B illustrates an exemplary fault-augmented diagnostic circuit, according to one embodiment of the instant application.

FIG. 5 illustrates the comparison between the outputs of the trained RNN and the physics-based model, according to one embodiment of the instant application.

FIG. 6 illustrates an optimized input sequence, according to one embodiment of the instant application.

FIG. 7 illustrates the system outputs for each of the four modes responsive to the optimized input sequence, according to one embodiment of the instant application.

FIG. 8 illustrates an exemplary confusion matrix constructed using the results of the classifier, according to one embodiment of the instant application,

FIG. 9 presents a flowchart illustrating an exemplary fault diagnostic process, according to one embodiment of the instant application.

FIG. 10 illustrates an exemplary apparatus for fault diagnosis, according to one embodiment of the instant application.

FIG. 11 illustrates an exemplary computer system that facilitates the diagnosis of physical systems, according to one embodiment of the instant application.

In the figures, like reference numerals refer to the same FIG. elements.

### DETAILED DESCRIPTION

The following description is presented to enable any person skilled in the art to make and use the embodiments and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown but is to be accorded the widest scope consistent with the principles and features disclosed herein.

### Overview

Embodiments described herein provide a system and method for diagnosing discrete faults in physical systems. The discrete faults can be modeled as operation modes, and a machine-learning classifier can be used to estimate the most likely operation mode of the system. To reduce the classification uncertainties, the classifier model and a model of the physical system can be coupled in tandem with the outputs of the system model being the inputs of the classifier model. More specifically, inputs to the system model and weights in the classifier model can be jointly trained by minimizing a cross-entropy loss function. Coupling the two models requires that the system model be compatible with the classifier model. Two different approaches can be used to construct the system model, a surrogate-model-based approach and an equation-based approach. In the surrogate-model-based approach, the physical system can be modeled as a neural network. In the equation-based approach, the physical system can be modeled using a set of equations. The trained classifier model can be used to predict the operation mode (or fault mode) of the physical system based on the system output responsive to the learned system input.

### Fault Diagnostic System

Faults in a physical system can often lead to abnormal system outputs. Using an analog circuit as an example, a circuit fault (e.g., an open or short circuit) can cause the circuit output to be different from its normal output. Machine-learning-based approaches have been used to diagnose circuit faults. For example, a classifier may be used to predict faults in a physical system based on the outputs of the system. However, the level of uncertainty of the classifier output can be high, as different types of faults may sometimes result in similar outputs.

In addition to the state (e.g., faulty or not faulty) of each component in a physical system, the output of the physical system can also depend on the input to the physical system. A physical system typically can respond differently to different inputs. For example, for a faulty system, a certain input may excite an output significantly more abnormal than outputs excited by different inputs. To reduce the uncertainty in fault diagnosis, in some embodiments, the classifier can be trained jointly with a model of the physical system. More specifically, the training objective can be learning the classifier weights and the input to the physical system that can minimize a cross-entropy loss function or maximize the difference between the outputs of the physical system in different operation modes.

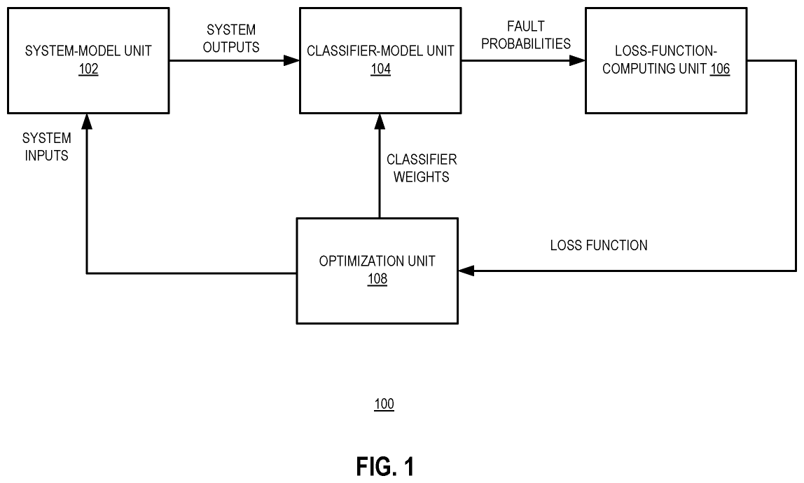

FIG. 1 illustrates an exemplary block diagram of the fault diagnostic system, according to one embodiment of the instant application. In FIG. 1, fault diagnostic system 100 can include a system-model unit 102, a classifier-model unit 104, a loss-function-computing unit 106, and an optimization unit 108.

System-model unit 102 can be responsible for modeling the to-be-diagnosed physical system. Given a sequence of inputs (e.g., a time sequence), system-model unit 102 can simulate the behavior of the physical system to generate a sequence of outputs. System-model unit 102 can include hardware components, software components, and a combination thereof. A to-be-diagnosed physical system can include different types of systems, such as a mechanical system, an analog circuit, an electro-optical system, an electro-mechanical system, a processor, a reversible computing circuit, a quantum circuit, an optical circuit, a quantum optical circuit, etc. System-model unit 102 can represent the system using a neural network or a set of mathematical equations (e.g., differential algebraic equations (DAEs) or ordinary differential equations (ODEs)).

Classifier-model unit 104 can include a machine-learning model such as a recurrent neural network (RNN). Various machine-learning tools can be used to implement classifier-model unit 104. In one embodiment, classifier-model unit 104 can be implemented using the PyTorch framework, where the classifier can be modeled as a PyTorch RNN. Like system-model unit 102, classifier-model unit 104 can include hardware components, software components, and a combination thereof. In one embodiment, the PyTorch RNN can be implemented using specialized hardware such as application-specific integrated circuits (ASICs).

Classifier-model unit 104 can take as input the output of system-model unit 102 and output the fault probabilities. For a physical system with discrete faults, each fault can be considered as an operation mode or fault mode of the physical system. In one embodiment, the output of classifier-model unit 104 can be the probability of each operation or fault mode. The system fault can be determined based on the operation or fault mode with the highest probability.

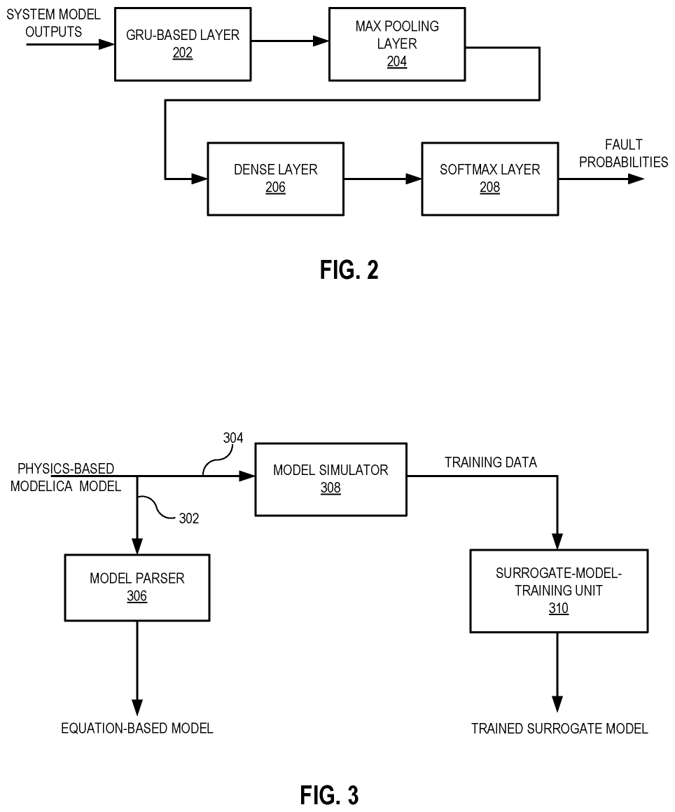

FIG. 2 illustrates the architecture of an exemplary classifier, according to one embodiment of the instant application. In FIG. 2, classifier 200 can be based on an RNN and can include a number of layers, a Gated Recurrent Unit (GRU)-based layer 202, a Max Pooling layer 204, a dense layer 206, and a SoftMax layer 208.

GRU-based layer 202 takes a sequence of outputs of the model of the physical system and generates another sequence of the same length. This sequence can pass through Max Pooling layer 204 to reduce the size of the sequence. The output of Max Pooling layer 204 can be sent to dense layer 206. A dense layer is also referred to as a fully connected layer and can be used to change the dimensions of the output from the preceding layer. SoftMax layer 208 can generate the model probabilities, i.e., the fault probabilities.

Returning to FIG. 1, loss-function-computing unit 106 can be responsible for computing a loss function based on the output sequence of classifier-model unit 104. In one embodiment, the loss function can be a cross-entropy loss function. Optimization unit 108 can implement an optimization algorithm to find the optimal input sequence and classifier weights that can minimize the cross-entropy loss function.

For an analog system, the physics-based model can be described using a set of DAEs in the following form:

0=F(\dot{x},x,u,w),x(0)=x₀, (1)

y=h(x,u,v), (2)

where x is the state vector, u is the vector of the inputs, w is the state noise, y is the vector of outputs, and v is the measurement noise. Equations (1) and (2) represent the system model under normal behavior. The system can be affected by a set of discrete faults (denoted as [symbol] ={f₁, . . . , F_{N}}) that change the system behavior. For simplicity of formulation, this disclosure assumes that the normal model is included in [symbol] .

Using θ to denote the mode of operation, the multi-mode system model can be represented as:

0=F_{θ}(\dot{x},x,u,w),x(0)=x_{θ}, (3)

y=h_{θ}(x,u,v), (4)

where θ denotes the current operation mode and takes values in a discrete set [symbol] ={1, . . . , N}, and index one corresponds to the normal behavior or mode.

The classifier can be represented by a mapping function p= [symbol] (y_{0:T}; w_{c}), where p=[p₁, . . . , p_{N}] represents the vector of mode probabilities, y_{0:T} is a sequence of output vectors responsible to a sequence of input vectors u_{0:T}, and w_{c} are the trainable parameters (e.g., weights) of the classifier.

In some embodiments, the training objective is to learn a sequence of inputs to system-model unit 102 and a set of classifier weights in classifier-model unit 104 such that the probabilities of the different operation modes are not similar, i.e., the prediction uncertainty is small. In some embodiments, the number of optimization variables can be controlled corresponding to the input sequence by imposing a maximum number of points to describe the inputs and assuming a piecewise constant input signal. Let m denote the number of points in the input sequence, the input signal over a time interval [0, T] can be expressed as u(t)=uⱼ[ [symbol] (t−tⱼ)− [symbol] (t−tⱼ₊₁)], for t∈[tⱼ,tⱼ₊₁) and j∈{1, . . . , M}, where [symbol] (t) denotes the step function. However, this initial representation of the input signal is not differentiable due to the step function. In some embodiments, an approximate smooth representation of the input signal can be generated by approximating the step function with a sigmoid function given by

$$σ ( t ) = \frac{1}{1 + {e}^{- t}} .$$

Accordingly, a smooth approximation of the piecewise constant input signal can be expressed as u(t)=uⱼ[σ(β(t−tⱼ))−σ(β(t−tⱼ₊₁))] for t∈[tⱼ,tⱼ₊₁) and j∈{1, . . . , M}, where β is a large positive constant.

During training, optimization unit 108 can be used to solve the following optimization problem:

$${min}_{{u}_{0 : T} ∈ U , {w}_{c}} - {\sum }_{i = 1}^{N} {\sum }_{j = 1}^{N} {z}_{j}^{( i )} log ( {z}_{j}^{( i )} ) , \qquad ( 5 )$$

$${y}_{0 : T}^{( i )} = System model ( {u}_{0 : T} ; θ = i ) , i ∈ \{ 1 , … , N \} , \qquad ( 6 )$$

$${z}^{( i )} = C ( {y}_{0 : T}^{( i )} ; {w}_{c} ) , {z}^{( i )} = [ {z}_{1}^{( i )} , … , {z}_{N}^{( i )} ] , i ∈ [ 1 , … , N ] , \qquad ( 7 )$$

$$u ( t ) = u [ σ ( β ( t - {t}_{l} ) ) - σ ( β ( t - {t}_{l + 1} ) ) ] , ∀ t ∈ [ {t}_{l} , {t}_{l + 1} ) , \qquad ( 8 )$$

$$∀ l ∈ \{ 1 , … , M \}$$

where formula (5) indicates the cross-entropy loss function, equation (6) indicates the output sequence of the system model of mode i (i.e., y_{0:T}), equation (7) indicates the probability of mode i, and equation (8) is the input signal over a time interval [0,T].

As can be seen from FIG. 1, the output of system-model unit 102 is the input to classifier-model unit 104, meaning that system-model unit 102 should be able to generate outputs that are compatible with the classifier model implemented by classifier-model unit 104. In addition, to take advantage of machine-learning platforms (e.g., PyTorch) featuring automatic differentiation, the model of the physical system should be constructed in a format compatible with such platforms to enable efficient model evaluations.

There can be two approaches for modeling a physical system, the machine-learning-based approach and the equation-based approach. The machine-learning-based approach can also be referred to as a surrogate-model approach, in which a surrogate model of the physical system can be trained using machine-learning techniques to simulate the behavior of the physical system. In some embodiments, to be compatible with the machine-learning platform implementing the classifier, the surrogate model can be represented using a neural network (NN), and in particular, an RNN, which can model the behaviors of dynamic systems. When PyTorch is used as the machine-learning platform, the surrogate model can include a PyTorch RNN.

In some embodiments, rather than learning one RNN for each operation mode, system-model unit 102 can learn an RNN that includes all operation modes, with a separate output for each mode. For example, if there are N possible types of faults, the system RNN should generate N separate outputs, one for each type of fault. The system RNN should also generate an output for the normal operation mode. In some embodiments, the surrogate model can be trained to mimic the response of the multi-mode, physics-based model using training data collected from the actual physical system or from running simulations. In one embodiment, the physics-based model can be represented using a modeling language (e.g., Modelica), and the training data for the surrogate model can be generated by simulating the Modelica model. The synthesis training data allows the system to generate as much training data as needed; hence, there is less worry about over-fitting the RNN.

The equation-based approach for modeling the physical system can be considered a white-box optimization problem and can include parsing the Modelica model of the physical system to extract equations (e.g., DAEs or ODEs) that govern the behavior of the model. The extracted equations can be expressed in a format that is compatible with the machine-learning platform. Note that the machine-learning platform (e.g., PyTorch) can include libraries for solving differential equations. The differential equations extracted from the Modelica model can be represented as PyTorch objects. During training, these differential equations can be simulated to generate outputs of the physical system, which can then be used as inputs to the classifier. Having the differential equations expressed as PyTorch objects can enable the use of automatic differentiation on the predicted system outputs, thus enabling automatic computation of the gradients of the cross-entropy loss function.

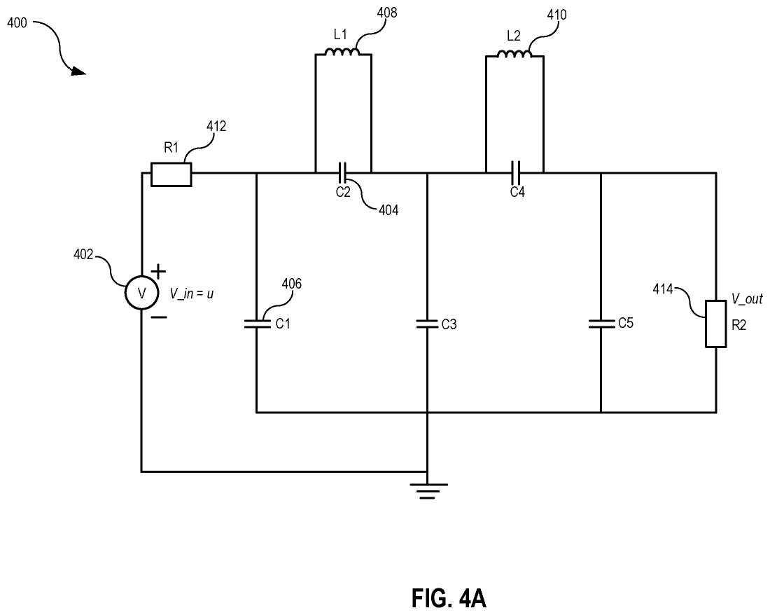

FIG. 3 illustrates the two exemplary approaches for modeling a physical system, according to one embodiment of the instant application. FIG. 3 shows a physics-based model (e.g., a Modelica model) can be sent to two branches: equation-based branch 302 and surrogate-model-based branch 304. To mimic a physical system with potential faults, the Modelica model can be fault augmented. Equation-based branch 302 can include a model parser 306 for parsing the fault-augmented Modelica model to extract equations that can represent the behaviors of the physical system with potential faults. The output of model parser 306 can be the equation-based model. On the other hand, surrogate-model-based branch 304 can include a model simulator 308 and a surrogate-model-training unit 310. Model simulator 308 can perform simulations based on the fault-augmented Modelica model to generate training data used to train surrogate-model-training unit 310. Performing the simulations can include solving the differential equations included in the Modelica model. Surrogate-model-training unit 310 can output a trained surrogate model (e.g., an RNN) of the physical system.

### An Analog Circuit Example

In this disclosure, an analog circuit is used as an example for demonstrating the principle of the proposed fault diagnostic solution. To diagnose faults in analog circuits, one can model the fault behaviors. In some embodiments, modeling of the faults can be achieved through fault augmentation, where an original circuit can be converted into a fault-augmented diagnostic circuit by including subcircuits that emulate possible faults (e.g., open, or short circuit, stuck-at-1, stuck-at-0, etc.).

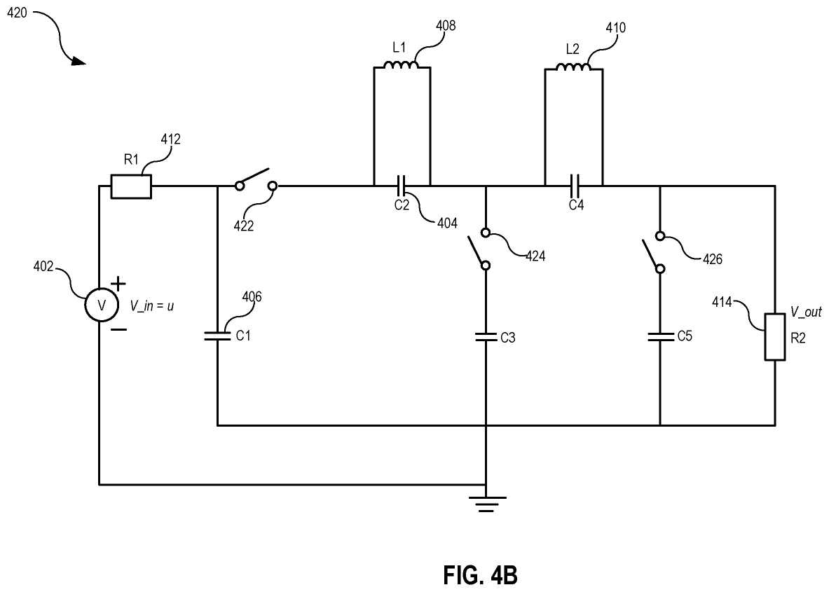

FIG. 4A illustrates an exemplary to-be-diagnosed analog circuit. In FIG. 4, analog circuit 400 can be a Cauer low-pass filter that includes a voltage source 402, a number of capacitors (e.g., capacitors 404 and 406), inductors 408 and 410, and resistors 412 and 414. The input signal to circuit 400 can be provided by voltage source 402, and the output signal of circuit 400 can be the voltage across resistor 414.

FIG. 4B illustrates an exemplary fault-augmented diagnostic circuit, according to one embodiment of the instant application. In FIG. 4B, analog circuit 420 can be similar to circuit 400 but include additional switches 422, 424, and 426. These switches can be used to emulate open-circuit faults in the low-pass filter. More specifically, an open switch can indicate an open-circuit fault at the corresponding circuit path.

In the example shown in FIG. 4B, analog circuit 420 can operate in four different operation modes, a normal mode (i.e., all switches are closed) and three different fault modes (e.g., one of the three switches is open). Note that this example only considers the single fault situation.

As discussed previously, analog circuit 420 can be modeled using an RNN with four outputs (each output corresponding to an operation mode), where y_{0:T}ⁱ corresponds to the behavior of the system in mode i, i∈{0, 1, 2, 3}, over the time interval [0, T]. The training data can be generated using the Modelica model. When generating the training data, inputs to analog circuit 420 can include persistent random signals (e.g., a Pseudo-Random Binary Sequence) that can excite the circuit at different frequencies to elicit diverse behaviors.

In one example, the random input signal sequences can cover a 20-second time interval (i.e., T=20 sec), sampled at every 0.02 sec. To obtain a sufficient number of training samples, 10000 such input signal sequences can be generated and used as inputs to the circuit model (i.e., the Modelica model) in each of the four operation modes. The four operation modes can be defined by the fault parameters (i.e., the open or close state of each switch). The four outputs can then be collected. In one example, the four outputs can be obtained from the four channels of the RNN.

In a further example, an RNN similar to the one shown in FIG. 2 can be trained using the PyTorch deep learning platform. The RNN model can include one hidden layer of size 40 using GRU cells, followed by a linear layer with a four-dimensional output. In some embodiments, the RNN can be trained using a gradient descent algorithm (e.g., the Adam algorithm). In one example, training the RNN can result in a mean square error (MSE) of 2.37×10⁻⁶.

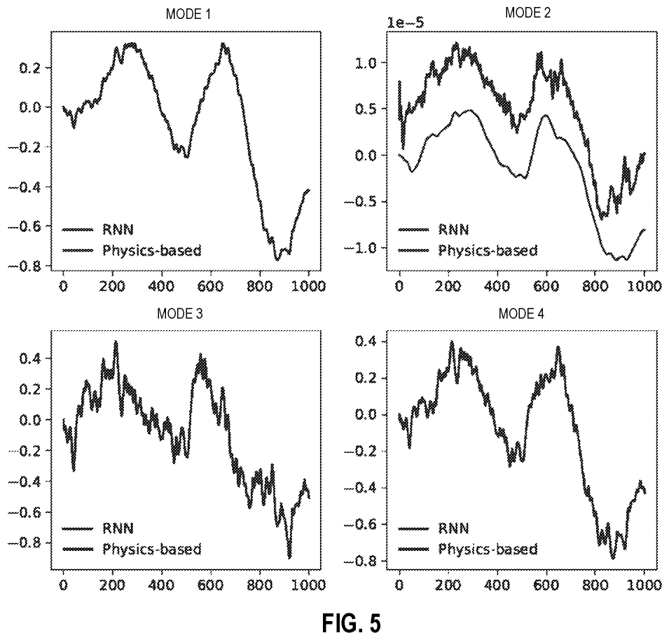

FIG. 5 illustrates the comparison between the outputs of the trained RNN and the physics-based model, according to one embodiment of the instant application. In FIG. 5, Mode 1, Mode 2, Mode 3, and Mode 4 refer to the four operation modes, with Mode 1 being the normal, no-fault mode. As can be seen from FIG. 5, the outputs of the RNN model match closely with the outputs of the physics-based model. Note that the difference between the two output sequences in Mode 2 appears to be larger due to the enlarged scale of that drawing. FIG. 5 demonstrates that the trained RNN model can closely mimic the behavior of circuit 420 in all four operation modes.

In alternative embodiments, instead of training a surrogate model, circuit 420 can be modeled by parsing the Modelica model to extract equations governing the behavior of circuit 420. For example, one can construct the circuit model using the Modelica language (or on the Modelica platform) and then use the Open Modelica scripting language (e.g., the dumpXMLDAE command) to dump the XML representation of the Modelica model. Next, a flat version of the model can be created by removing the hierarchy of the model and replacing the connect statements with equations reflective of the connect statement semantics. The flat model can be further processed to create a simplified model, where trivial equations can be removed through Gaussian elimination. In some embodiments, the simplified model can include a set of semi-explicit DAEs, which can then be used to rebuild a Modelica file using the Modelica_builder Python library. Alternatively, the DAEs can be converted into SymPy (which is an open-source Python library for symbolic computation) objects. These objects can be further transformed and integrated into an optimization framework featuring automatic differentiation or AD (e.g., the PyTorch platform). This allows the physics-based circuit model to be integrated with the RNN model of the classifier.

When the surrogate model is coupled to the classifier model to predict system outputs, the output sequence for each of the four modes can be generated simultaneously. When the equation-based model is integrated with the classifier mode, the model is simulated for each mode for a sequence of inputs determined by the optimization algorithm.

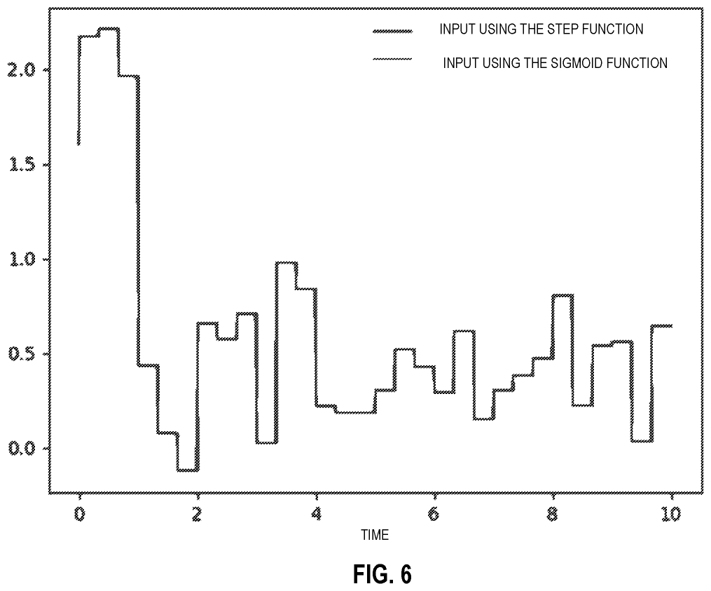

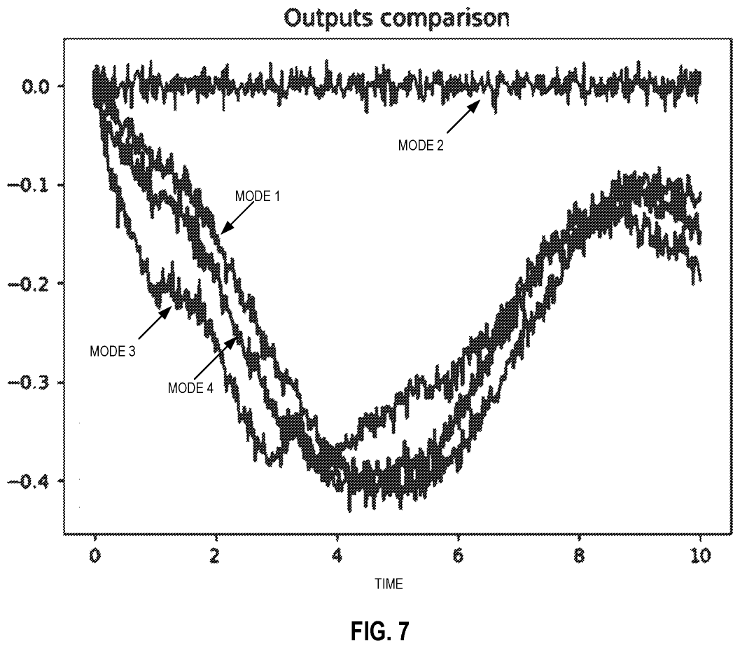

In one example, a gradient descent algorithm (e.g., Adam) can be used to solve the optimization problem in PyTorch. More particularly, 2000 iterations can be performed with a constant step size of 0.001. White Gaussian noise can be added to the output generated by the model of the physical system to construct a classifier robust to noise. FIG. 6 illustrates an optimized input sequence, according to one embodiment of the instant application. As can be seen from FIG. 6, the difference between the input signal expressed using the step function and the input signal expressed using the sigmoid function can be minimum. FIG. 7 illustrates the system outputs for each of the four modes responsive to the optimized input sequence, according to one embodiment of the instant application. As shown in FIG. 7, when the optimized input sequence is applied to the to-be-diagnosed physical system, the system may generate significantly different outputs for different operation modes. Therefore, a classifier can easily determine the operation mode (or fault mode) of the to-be-diagnosed physical system based on the system output.

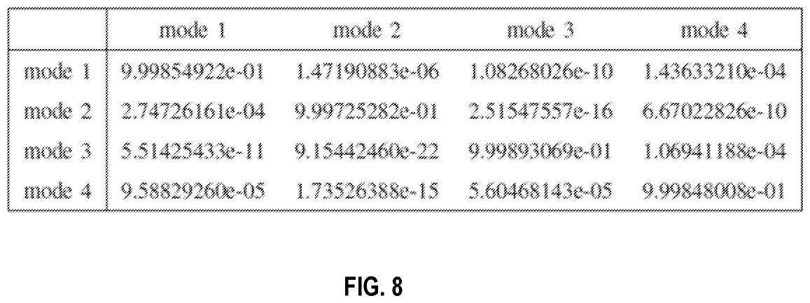

FIG. 8 illustrates an exemplary confusion matrix constructed using the results of the classifier, according to one embodiment of the instant application. As can be seen from FIG. 8, the correct operation mode (i.e., the diagonal elements of the matrix) can have a much higher probability than incorrect modes. This means that the trained model can successfully predict the fault in the circuit.

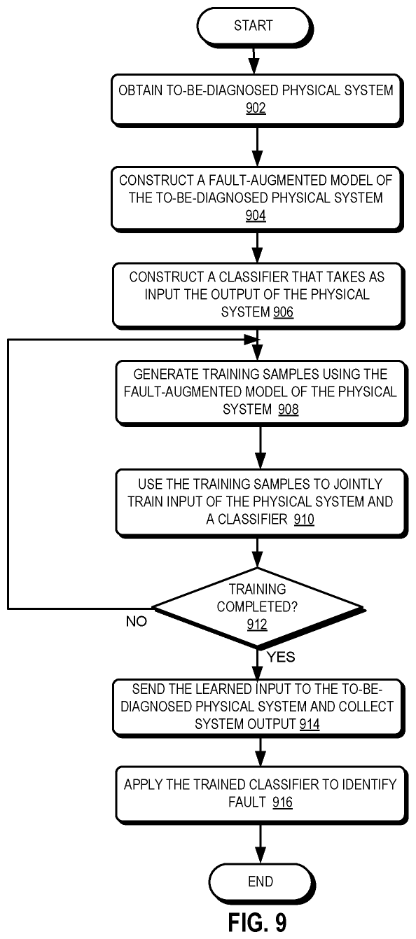

FIG. 9 presents a flowchart illustrating an exemplary fault diagnostic process, according to one embodiment of the instant application. During operation, a to-be-diagnosed physical system can be obtained (operation 902). The to-be-diagnosed physical system can include but is not limited to a mechanical system, an electrical system (e.g., an analog or digital circuit), an electro-optical system, an electro-mechanical system, a processor, a reversible computing circuit, a quantum circuit, an optical circuit, a quantum optical circuit, etc. For the diagnosis of an analog circuit, the diagnostic system can obtain the design model (e.g., a Modelica model) of the analog circuit.

The diagnostic system can construct a fault-augmented model of the to-be-diagnosed physical system (operation 904). In some embodiments, the constructed model should be compatible with a machine-learning platform (e.g., PyTorch). In one example, constructing the model can include extracting differential equations from the fault-augmented design model (e.g., a Modelica model) of the to-be-diagnosed physical system. The different equations can be represented as objects in the machine-learning platform. In another example, constructing the model can include training a neural network (e.g., an RNN) to mimic the behaviors (including both the normal and faulty behaviors) of the physical system. Training samples for the RNN can be obtained by running simulations on the fault-augmented Modelica model of the physical system.

The diagnostic system can construct a classifier that takes as input the output of the physical system (operation 906). In some embodiments, the classifier can include an RNN. The diagnostic system can subsequently generate training samples using the constructed fault-augmented model of the physical system (operation 908). The training samples include the input and output sequences of the physical system and can be labeled for the different operation modes. In one embodiment, generating an input sequence can include approximating the step function using a sigmoid function. In one embodiment, generating the training samples can also include adding random noise (e.g., white Gaussian noise) to the simulated system output sequence. If the model of the physical system is an RNN, the model can generate outputs of different operation modes (or training samples with different labels) simultaneously. If the model is based on equations, the model can generate outputs for each operation mode separately.

The diagnostic system can then use the training samples to jointly train the inputs of the physical system and the classifier (operation 910). In some embodiments, through training, the diagnostic system can learn the inputs and classifier weights that can minimize a cross-entropy loss function. The diagnostic system can then determine whether the training is completed based on a predetermined optimization threshold (operation 912). If the training is not completed, the system can generate more training samples (operation 908). If the training is completed, the system can send the learned input sequence to the to-be-diagnosed physical system and collect the system output sequence responsive to the learned input sequence (operation 914). The diagnostic system can then apply the trained classifier on the output of the physical system to identify a fault (operation 916). More specifically, the diagnostic system can output the probabilities of the different operation modes of the physical system. The operation mode with the highest probability can be considered the predicted system operation mode, with can be the normal operation mode or one of the discrete fault modes.

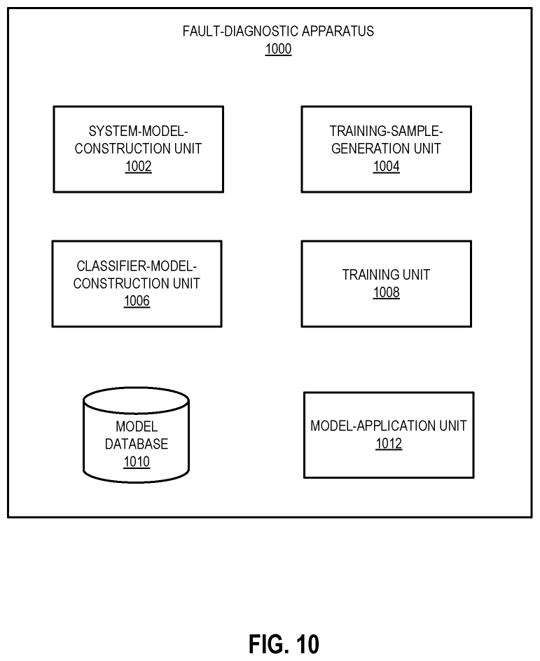

FIG. 10 illustrates an exemplary apparatus for fault diagnosis, according to one embodiment of the instant application. Fault-diagnostic apparatus 1000 can include a system-model-construction unit 1002, a training-sample-generation unit 1004, a classifier-model-construction unit 1006, a training unit 1008, a model database 1010, and a model-application unit 1012.

System-model-construction unit 1002 can be responsible for constructing a model of the to-be-diagnosed physical system. The constructed model can be compatible with a machine-learning platform (e.g., PyTorch). In some embodiments, constructing the model can involve training an RNN using training samples generated by a fault-augmented design or physics-based model (e.g., a Modelica model) of the physical system. In some embodiments, constructing the model can involve extracting differential equations from a fault-augmented physics-based model.

Training-sample-generation unit 1004 can be responsible for generating training samples using the model of the to-be-diagnosed physical system. Training-sample-generation unit 1004 can use random inputs and random fault parameters to generate model outputs, and each training sample can include the input sequence, the fault parameter, and the corresponding output sequence.

Classifier-model-construction unit 1006 can be responsible for constructing a deep learning model (e.g., an RNN) for classifying the outputs of the to-be-diagnosed physical system. Training unit 1008 can be responsible for jointly training the inputs of the physical system and the classifier weights. Model database 1010 can be responsible for storing the trained model. Model-application unit 1012 can be responsible for applying the trained model and the learned input sequence to the physical system to predict the system fault. More specifically, model-application unit 1012 can apply the learned input sequence to the physical system to obtain the output sequence of the system responsive to the learned input sequence. The system output sequence can then be sent to the trained classifier, which can predict the current operation mode of the physical system by classifying the output sequence.

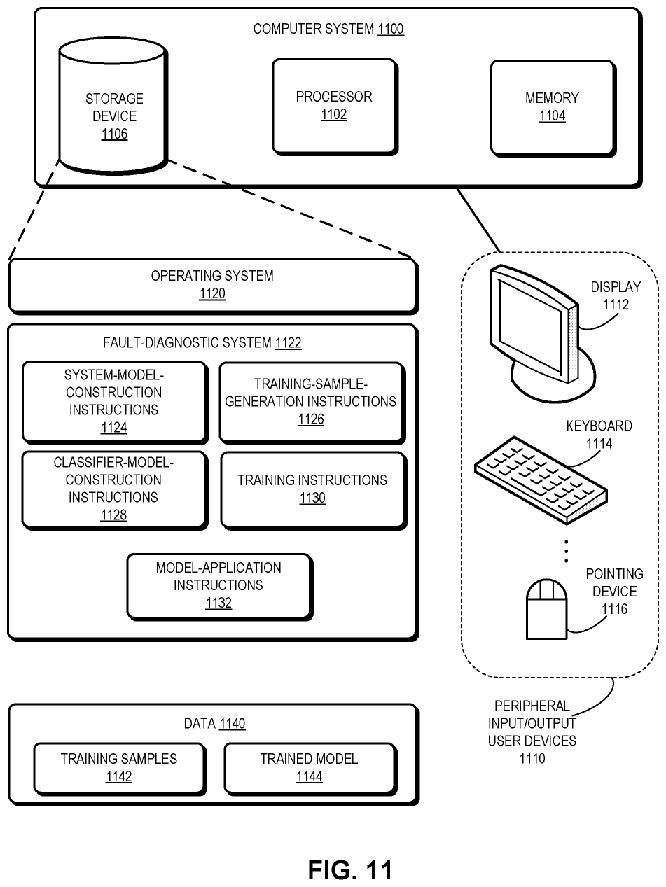

FIG. 11 illustrates an exemplary computer system that facilitates the diagnosis of physical systems, according to one embodiment. Computer system 1100 includes a processor 1102, a memory 1104, and a storage device 1106. Furthermore, computer system 1100 can be coupled to peripheral input/output (I/O) user devices 1110, e.g., a display device 1112, a keyboard 1114, and a pointing device 1116. Storage device 1106 can store an operating system 1120, a diagnostic system 1122, and data 1140.

Diagnostic system 1122 can include instructions, which when executed by computer system 1100, can cause computer system 1100 or processor 1102 to perform methods and/or processes described in this disclosure. Specifically, diagnostic system 1122 can include instructions for constructing a machine-learning compatible model of the physical system (system-model-construction instructions 1124), instructions for generating training samples (training-sample-generation instructions 1126), instructions for constructing a classifier model (classifier-model-construction instructions 1128), instructions for training the classifier model jointly with the system inputs (training instructions 1130), and instructions for applying the input and classifier model to the physical system (model-application instructions 1136). Data 1140 can include training samples 1142 and a trained model 1144.

In general, the disclosed embodiments can provide a system and method for diagnosing discrete faults in physical systems (e.g., an analog circuit). The diagnostic system can construct a machine-learning-compatible model of a to-be-diagnosed physical system. The machine-learning-compatible model can be a neural network or a set of differential equations. The diagnostic system can integrate such a model with a classifier, which is implemented on a machine-learning platform (e.g., PyTorch). The diagnostic system can jointly train the system inputs and the classifier. For example, an input sequence and a set of classifier weights that can minimize a cross-entropy loss function (or maximize the difference in the system outputs among the different operation modes) can be learned. The learned system input and classifier can be applied to the physical system to predict the operation mode (or fault mode) of the physical system.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method for diagnosing faults in a physical system, the method comprising:
constructing, by a computer, a fault-augmented model of the physical system based on a number of potential faults in the physical system;
constructing a machine-learning model for predicting an operation mode of the physical system based on outputs of the physical system, wherein a respective operation mode corresponds to normal operation or a potential fault in the physical system;
generating a plurality of training samples based on the fault-augmented model;
using the training samples to train the machine-learning model to learn a sequence of inputs and model parameters that minimizes uncertainty of the predicted operation mode; and
applying the learned sequence of inputs and the trained machine-learning model on the physical system to determine the operation mode of the physical system.

2. The method of claim 1, wherein the fault-augmented model comprises a neural network, and wherein constructing the fault-augmented model further comprises simulating behaviors of the physical system using a physics-based model to obtain training data to train the neural network.

3. The method of claim 1, wherein constructing the fault-augmented model comprises:
extracting a set of differential equations from a physics-based model of the physical system; and
representing the differential equations as objects in a machine-learning platform upon which the machine-learning model is constructed.

4. The method of claim 3, wherein the physics-based model comprises a Modelica model.

5. The method of claim 1, wherein generating the training samples comprises generating an approximate smooth representation of a sequence of inputs by approximating a step function with a sigmoid function.

6. The method of claim 1, wherein generating the training samples comprises adding white Gaussian noise to outputs of the fault-augmented model.

7. The method of claim 1, wherein training the machine-learning model comprises applying a gradient descent algorithm.

8. The method of claim 1, wherein the machine-learning model comprises a recurrent neural network (RNN)-based classifier.

9. A non-transitory computer-readable storage medium storing instructions that when executed by a computer cause the computer to perform a method for diagnosing faults in a physical system, the method comprising:
constructing a fault-augmented model of the physical system based on a number of potential faults in the physical system;
constructing a machine-learning model for predicting an operation mode of the physical system based on outputs of the physical system, wherein a respective operation mode corresponds to normal operation or a potential fault in the physical system;
generating a plurality of training samples based on the fault-augmented model;
using the training samples to train the machine-learning model to learn a sequence of inputs and model parameters that minimizes uncertainty of the predicted operation mode; and
applying the learned sequence of inputs and the trained machine-learning model on the physical system to determine the operation mode of the physical system.

10. The non-transitory computer-readable storage medium of claim 9, wherein the fault-augmented model comprises a neural network, and wherein constructing the fault-augmented model further comprises simulating behaviors of the physical system using a physics-based model to obtain training data to train the neural network.

11. The non-transitory computer-readable storage medium of claim 9, wherein constructing the fault-augmented model comprises:
extracting a set of differential equations from a physics-based model of the physical system; and
representing the differential equations as objects in a machine-learning platform upon which the machine-learning model is constructed.

12. The non-transitory computer-readable storage medium of claim 11, wherein the physics-based model comprises a Modelica model.

13. The non-transitory computer-readable storage medium of claim 9, wherein generating the training samples comprises generating an approximate smooth representation of a sequence of inputs by approximating a step function with a sigmoid function.

14. The non-transitory computer-readable storage medium of claim 9, wherein generating the training samples comprises adding white Gaussian noise to outputs of the fault-augmented model.

15. The non-transitory computer-readable storage medium of claim 9, wherein training the machine-learning model comprises applying a gradient descent algorithm.

16. The non-transitory computer-readable storage medium of claim 9, wherein the machine-learning model comprises a recurrent neural network (RNN)-based classifier.

17. A computing system for computing for diagnosing faults in a physical system, the system comprising:
a processor;
a storage device coupled to the processor, wherein the storage device storing instructions which, when executed by the processor, cause the processor to perform a method for diagnosing faults in a physical system, the method comprising:
constructing a fault-augmented model of the physical system based on a number of potential faults in the physical system;
constructing a machine-learning model for predicting an operation mode of the physical system based on outputs of the physical system, wherein a respective operation mode corresponds to normal operation or a potential fault in the physical system;
generating a plurality of training samples based on the fault-augmented model;
using the training samples to train the machine-learning model to learn a sequence of inputs and model parameters that minimizes uncertainty of the predicted operation mode; and
applying the learned sequence of inputs and the trained machine-learning model on the physical system to determine the operation mode of the physical system.

18. The computing system of claim 17, wherein the fault-augmented model comprises a neural network, and wherein constructing the fault-augmented model further comprises simulating behaviors of the physical system using a physics-based model to obtain training data to train the neural network.

19. The computing system of claim 17, wherein constructing the fault-augmented model comprises:
extracting a set of differential equations from a physics-based model of the physical system; and
representing the differential equations as objects in a machine-learning platform upon which the machine-learning model is constructed.

20. The computing system of claim 17, wherein generating the training samples comprises one or more of:
generating an approximate smooth representation of a sequence of inputs by approximating a step function with a sigmoid function; and
wherein generating the training samples comprises adding white Gaussian noise to outputs of the fault-augmented model.
